(19) United States
(12) Patent Application Publication
(10) Pub. No.: US 2010/0287720 A1
(43) Pub. Date: Nov. 18, 2010

(54) Soap Dispensing Bath Mitt

(76) Inventors: Ted Anthony Kayata, SR., Williamsburg, OH (US); Rebecca Ann Kayata, Williamsburg, OH (US)

Correspondence Address: Ted Anthony Kayata Sr., 3125 Pennington Ln., Williamsburg, OH, 45176, US

(21) Appl. No.: 12/769,871

(22) Filed: Apr. 29, 2010

Related U.S. Application Data
(60) Provisional application No. 61/177,359, filed on May 12, 2009.

(51) Int. Cl. B43L 21/00

(52) U.S. Cl. 15/227

(57) ABSTRACT

An apparatus includes a mitt having a multi-layer material. The mitt has a first side, a second side and a lower opening. A pocket is disposed on an upper portion of the first side for retaining soap. The pocket includes tight mesh material for generally retaining liquid soap. The tight mesh material has a plurality of apertures for enabling water to enter, and lather from the soap to permeate out. A closure device maintains the pocket in a closed position during use. An exfoliating material is joined to the second side for enabling the user to deep clean during a washing process. Means joins objects to the apparatus for enabling user entertainment during the washing process. A loop is joined to the mitt for enabling the user to hang the apparatus. A securing device is disposed proximate the lower opening for enabling a user to secure the apparatus during use.

### CROSS-REFERENCE TO RELATED APPLICATIONS

The present Utility patent application claims priority benefit of the U.S. provisional application for patent Ser. No. 61/177,359 filed on 12 May 2009 under 35 U.S.C. 119(e). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to personal care items. More particularly, the invention relates to a soap dispensing bath mitt.

### BACKGROUND OF THE INVENTION

Many children do not enjoy their nightly bath or shower, and it can be difficult for parents to make bath time fun and exciting. Convincing children to wash thoroughly can be a tedious task. Children often find washcloths to be boring and quickly lose interest. Also, it can be difficult for children to maneuver bar soap when using a regular washcloth, especially when the bar becomes small and breaks into little pieces. People typically throw away these small pieces of soap thereby wasting money. Moreover, it is difficult to find space in the bathing area for storing loofahs, toys, washcloths, soap bars and dispensers, etc.

In view of the foregoing, there is a need for improved techniques for providing means for bathing that interests children and saves space and soap.

### BRIEF DESCRIPTION OF THE DRAWINGS

The present invention is illustrated by way of example, and not by way of limitation, in the figures of the accompanying drawings and in which like reference numerals refer to similar elements and in which:

FIGS. 1A through 1C illustrate an exemplary bath mitt, in accordance with an embodiment of the present invention. FIG. 1A is a partial perspective view of the mitt in which the mitt is secured on the hand of a user. FIG. 1B is a partial perspective view of the mitt in which a first side of the mitt is illustrated, and FIG. 1C is a partial perspective view of the mitt in which a second side of the mitt is illustrated; and

FIGS. 2A and 2B illustrate an exemplary bath mitt, in accordance with an embodiment of the present invention. FIG. 2A is a partial perspective view of the mitt in which a toy has been attached directly to the mitt, and FIG. 2B is a partial perspective view of the mitt in which a toy has been attached to the mitt with a third securing means.

Unless otherwise indicated illustrations in the figures are not necessarily drawn to scale.

### SUMMARY OF THE INVENTION

To achieve the forgoing and other objects and in accordance with the purpose of the invention, a soap dispensing bath mitt is presented.

In one embodiment an apparatus includes means for generally enclosing a hand space, means for retaining a soap, enabling water to enter, and lather from the soap to permeate out, and means for enabling a user to removably secure the apparatus during use, thereby enabling the user to use the apparatus in a washing process. Another embodiment further includes means for generally maintaining the retaining means a closed position during use. Yet another embodiment further includes means for enabling the user to deep clean during the washing process. Still another embodiment further includes means for enabling the user to hang the apparatus when not in use. Another embodiment further includes means for joining objects to the apparatus for enabling user entertainment during the washing process.

In another embodiment an apparatus includes a covering member including a first side, a second side and a lower opening for generally enclosing a hand space. A pocket is disposed on the first side for retaining a soap, the pocket including a plurality of apertures for enabling water to enter, and lather from the soap to permeate out through the apertures. A securing device is disposed proximate the lower opening for enabling a user to removably secure the apparatus during use, thereby enabling the user to use the apparatus in a washing process. Another embodiment further includes a closure device for generally maintaining the pocket in a closed position during use. Yet another embodiment further includes an exfoliating material joined to the covering member for enabling the user to deep clean during the washing process. Still another embodiment further includes a loop-like structure for enabling the user to hang the apparatus when not in use. Another embodiment further includes means for joining objects to the apparatus for enabling user entertainment during the washing process. In yet another embodiment the exfoliating material is joined to the second side. In still another embodiment the pocket is disposed on an upper portion of the first side. In another embodiment the pocket further includes a tight mesh material for generally retaining liquid soap. In yet another embodiment the covering member further includes a multiple layer material. In still another embodiment an outside layer of the multiple layer material includes terrycloth. In another embodiment an inside layer of the multiple layer material includes a sponge like material. In yet another embodiment the covering member has a mitt shape.

In another embodiment an apparatus includes a hand-covering mitt including a multi-layer material. The hand-covering mitt has a first side, a second side and a lower opening for generally enclosing a hand space. A pocket is disposed on an upper portion of the first side for retaining a soap. The pocket includes tight mesh material for generally retaining liquid soap. The tight mesh material has a plurality of apertures for enabling water to enter, and lather from the soap to permeate out through the apertures. A closure device generally maintains the pocket in a closed position during use. An exfoliating material is joined to the second side for enabling the user to deep clean during a washing process. Means joins objects to the apparatus for enabling user entertainment during the washing process. A loop is joined to the hand-covering mitt for enabling the user to hang the apparatus when not in use. A securing device is disposed proximate the lower opening for enabling a user to removably secure the apparatus during use, thereby enabling the user to use the apparatus in the washing process. In another embodiment an outside layer of the multi-layer material includes terrycloth. In yet another embodiment an inside layer of the multi-layer material includes a sponge like material.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

The super soap saver mitt is a mitt/glove used to wash/exfoliate the body; this invention is unique in that it provides a hassle free way to dispense soap, as you wash your body or exfoliate your skin, in one handy device. The “Super Soap Saver” is a glove made of soft terry cloth that can be used for washing the face or body. It can be used by adults and children alike and will make bathing an easier task. It consists of a mitt type glove that will come in small, medium and large sizes and will have an integrated pocket to accept slivers of soap. Simply slip the mitt on, lather up and wash off. The Super Soap Saver would be available in different colors and designs with a variety of pictures, logos, mascots and cartoons.

Preferred embodiments of the present invention provide a device for holding soap and washing a person's body. The device in preferred embodiments comprises a cloth mitt with a pocket disposed thereon, which may be filled with soap; the pocket enables soap to permeate through the pocket as a user is washing his or her body. In preferred embodiments the pocket is disposed on a first side of the mitt, and an exfoliating means is disposed on a second side of the mitt. When wearing a mitt according to preferred embodiments, a user can lather his or her body with soap using the pocketed side then use the exfoliating means on the opposite side of the mitt to exfoliate his or her skin. Preferred embodiments are designed to conserve soap and thereby save the user money and to provide a more pleasurable bathing experience. Preferred embodiments generally eliminate the possibility of dropping the soap while bathing and also enable the user to utilize all of the soap, reducing waste. To add to the pleasure of the bathing experience in preferred embodiments, toys may be secured to the mitt. Preferred embodiments are meant to combine a washing device with an exfoliating device and toys, enabling a user to save money, to add convenience and fun to the bathing process, and to conveniently store various items in one place.

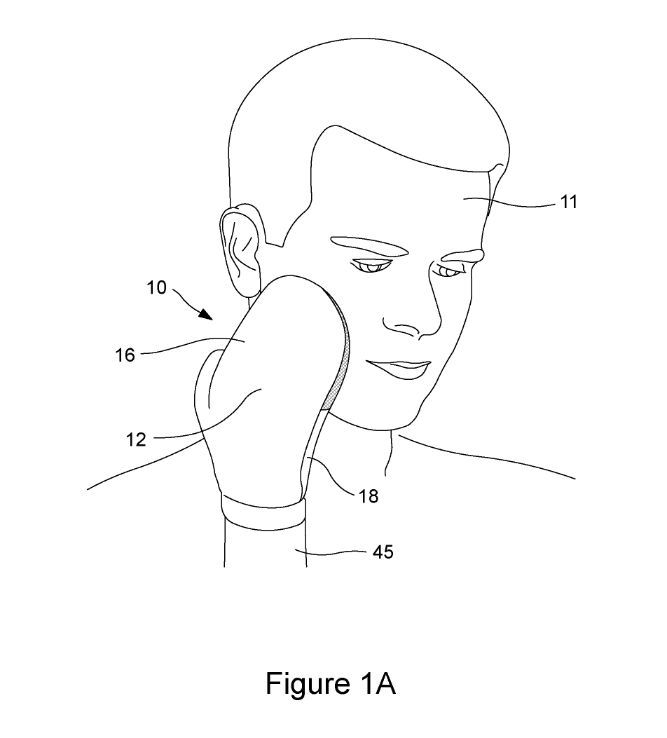

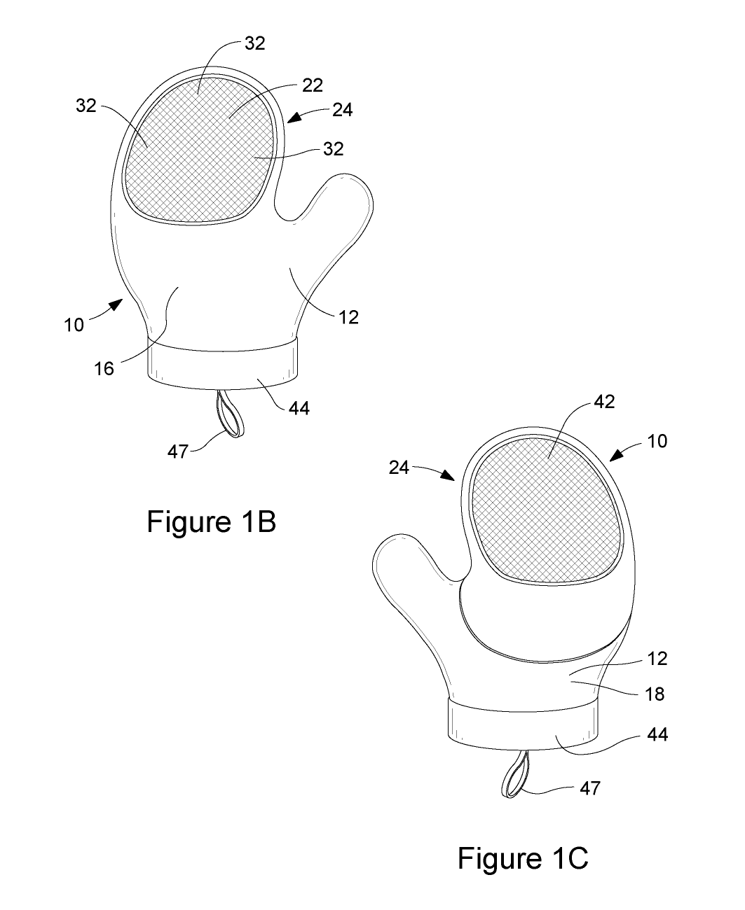

FIGS. 1A through 1C illustrate an exemplary bath mitt 10, in accordance with an embodiment of the present invention. FIG. 1A is a partial perspective view of mitt 10 in which mitt 10 is secured on the hand of a user 11. FIG. 1B is a partial perspective view of mitt 10 in which a first side 16 of mitt 10 is illustrated, and FIG. 1C is a partial perspective view of mitt 10 in which a second side 18 of mitt 10 is illustrated. In the present embodiment, mitt 10 is a combination washing and exfoliating device. Mitt 10 comprises a hand-covering member 12 for enclosing a space for a hand (not shown) of user 11. It is presently preferred that hand-covering member 12 is in the shape of a mitt; however, in alternate embodiments the hand-covering member may have various different shapes such as, but not limited to, a glove, a round shape, a rectangular shape, etc. In the present embodiment, hand-covering member 12 is preferably made in part of a terry cloth material. Mitt 10 comprises first side 16 and second side 18. First side 16 comprises a pocket 22 disposed in the upper portion of mitt 10. Pocket 22 includes a first securing means 24 for securing pocket 22 in a closed position during use. First securing means 24 is preferably a zipper; however various different types of securing means may be used such as, but not limited to snaps, buttons, hook and loop material, etc. In the present embodiment, pocket 22 further includes a plurality of apertures 32. It is meant that soap (not shown) is to be placed within pocket 22 and, as mitt 10 is wetted and used, such soap lathers and permeates through apertures 32. For example, without limitation, pocket 22 may be made of a mesh material. The soap placed in pocket 22 may be bar soap, or pocket 22 may be made of a tighter nylon mesh to accommodate liquid soap. Pocket 22 is preferably manufactured from vinyl or nylon; however, other materials may be used. In the present embodiment, an exfoliating means 42 is disposed on second side 18 of mitt 10. Exfoliating means 42 may be a loofah, a sponge, a scrubbing pad, or a combination thereof for the deep cleaning of the skin. Alternate embodiments may be implemented without exfoliating means. In the present embodiment, mitt 10 comprises multiple layers, and it is presently preferred that hand-covering member 12 has an outer covering of terrycloth and an inner lining of a cotton and polyester blend. In some alternate embodiments the inner lining may comprise a thin sponge, and other alternate embodiments may have no inner layer. In the present embodiment, a second securing means 44 is disposed on the lower portion of mitt 10 for securing mitt 10 to a wrist 45 of user 11 in a releasable manner. Second securing means 44 is preferably a wrist strap that can be adjusted for different wrist sizes. Second securing means 44 may secure to wrist 45 using various different means such as, but not limited to, hook and loop material, elastic, snaps, etc. Mitt 10 may be manufactured in different universal sizes to accommodate hand spaces for children to adults or may be manufactured in specific sizes such as, but not limited to, adult small, adult medium, adult large, child's small, child's medium, child's large, etc. Furthermore, mitt 10 may be made with different colors, designs, logos, and mascots for greater mass appeal.

Referring to FIG. 1A in typical use of the present embodiment, user 11 begins by placing a desired soap into pocket 22 and closes first securing means 24. Then, user 11 places hand-covering member 12 over his hand. Mitt 10 fits and secures to the hand of user 11 with second securing means 44 around wrist 45 for comfort and ease of washing the body in the shower or tub. Mitt 10 combines the exfoliation and washing of the body in one device by enabling user 11 to wash using first side 16 comprising pocket 22 and exfoliate using second side 18 comprising exfoliating means 42. Mitt 10 enables user 11 to save money by being able to use an entire bar of soap instead of throwing the soap away after it becomes small or breaks into pieces. Mitt 10 also generally eliminates the cumbersome task of handling bar soap for children. Second securing means 44 may be used to hang mitt 10 in the shower or bath area. In the present embodiment, a hook or loop 47 is disposed on mitt 10 that may also be used for hanging mitt 10 in the shower or bath area. This enables mitt 10 to be stored in a handy location, for example, without limitation, on the wall of the shower. Mitt 10 also saves space by combining the functions of multiple items, such as, but not limited to, a washcloth, a sponge, a loofah, soap, toys etc., into one device.

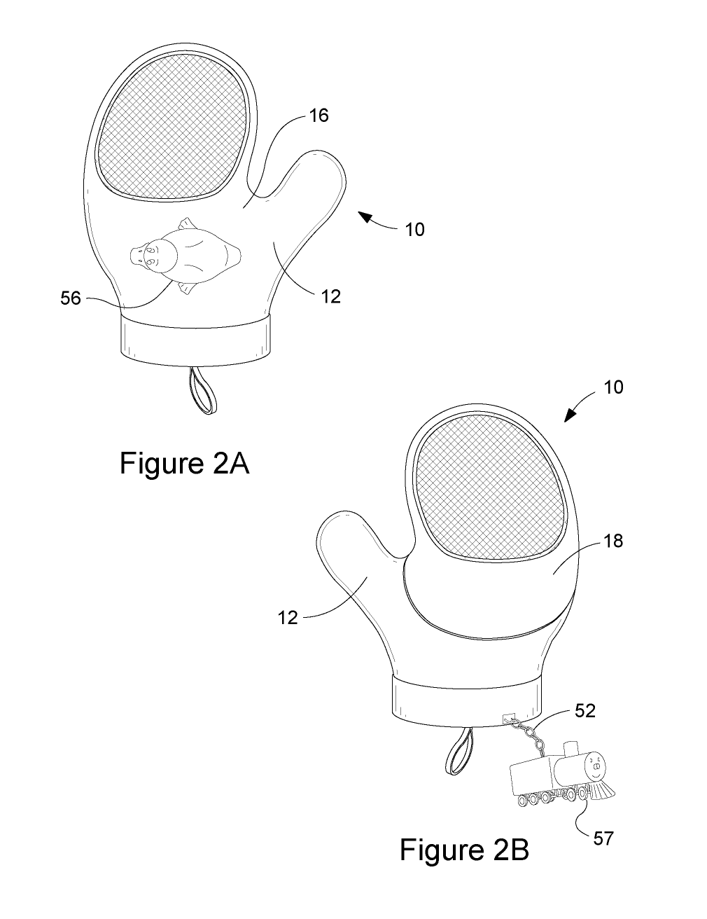

FIGS. 2A and 2B illustrate an exemplary bath mitt 10, in accordance with an embodiment of the present invention. FIG. 2A is a partial perspective view of mitt 10 in which a toy 56 has been attached directly to mitt 10, and FIG. 2B is a partial perspective view of mitt 10 in which a toy 57 has been attached to mitt 10 with a third securing means 52. In the present embodiment, toys 56 and 57 may be attached to mitt 10 for children to play with in order to make the task of bathing easier and more enjoyable for these children. Toys 56 and 57 may be bath toys such as, but not limited to, squeezable water receiving and dispensing toys, squeaking toys, singing toys, etc. Toys 56 and 57 are preferably made of vinyl and may have various different shapes and designs such as, but not limited to, animals or cartoon characters. These features add more fun and excitement to bath time. Referring to FIG. 2A, toy 56 is attached directly to a hand-covering member 12 of mitt 10 with means such as, but not limited to, hook and loop material, clips, clamps, etc., and may include a first portion of the attachment means disposed on mitt 10 and a second portion of the attachment means disposed on toy 56. Alternately, attachment means on toy 56 may attach directly to the terry cloth material of hand-covering member 12. Referring to FIG. 2B, toy 57 is attached to hand-covering member 12 by a third securing means 52, which is disposed on an outer portion of hand-covering member 12. Third securing means 52 comprises plastic rings with a release clip to attach and remove toy 57 to and from mitt 10. However in alternate embodiments, different types of securing means may be used as third securing means such as, but not limited to, a plastic wire with a release clip, a terry cloth strap with a snap or hook and loop material, an elastic strap, etc. In the present embodiment, toy 56 is shown attached directly to a first side 16 of mitt 10, and toy 57 is shown attached to a second side 18 of mitt 10 with third securing means 57. However, toy 56 may be attached directly to second side 18, and toy 57 may be attached to first side 16 with third securing means 57 if the user so desires.

Alternate embodiments of the present invention may comprise a pocket and exfoliating means on the same side of the device. For example, without limitation, one such embodiment is a mitt, similar to mitt 10 described by way of example in the foregoing, with a pocket and exfoliating means disposed on the same side. Another alternate embodiment, which is a flat device rather than a mitt in which a hand can be placed, comprises a pocket and exfoliation means on one side and a strap that secures around a user's hand disposed on the opposite side. In these embodiments the pocket and the exfoliating means may be combined into a single unit by placing the exfoliating means over the pocket or the pocket and the exfoliating means may be separate from each other. For example, without limitation, the pocket may be disposed on the top of the device with the exfoliating means on the bottom or vice versa.

Those skilled in the art, in light of the present teachings, will readily recognize that alternate embodiments of the present invention may be implemented for washing items other than a person's body such as, but not limited to, dishes, windows, vehicles, etc. In these embodiments the pockets may be modified in order to accommodate the particular type of cleaner used.

Having fully described at least one embodiment of the present invention, other equivalent or alternative methods of providing a personal cleaning device according to the present invention will be apparent to those skilled in the art. The invention has been described above by way of illustration, and the specific embodiments disclosed are not intended to limit the invention to the particular forms disclosed. For example, the particular implementation of the cleaning device may vary depending upon the particular type of means for holding the device used. The cleaning devices described in the foregoing were directed to wearable implementations; however, similar techniques are to provide non-wearable devices such as, but not limited to, a sponge-like device that is hand held, devices on long or short handles, etc. Non-wearable implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. An apparatus comprising:
means for generally enclosing a hand space;
means for retaining a soap, enabling water to enter, and lather from the soap to permeate out; and
means for enabling a user to removably secure the apparatus during use, thereby enabling the user to use the apparatus in a washing process.

2. The apparatus as recited in claim 1, further comprising means for generally maintaining said retaining means a closed position during use.

3. The apparatus as recited in claim 1, further comprising means for enabling the user to deep clean during the washing process.

4. The apparatus as recited in claim 1, further comprising means for enabling the user to hang the apparatus when not in use.

5. The apparatus as recited in claim 1, further comprising means for joining objects to the apparatus for enabling user entertainment during the washing process.

6. An apparatus comprising:
a covering member comprising a first side, a second side and a lower opening for generally enclosing a hand space;
a pocket disposed on said first side for retaining a soap, said pocket comprising a plurality of apertures for enabling water to enter, and lather from the soap to permeate out through said apertures; and
a securing device disposed proximate said lower opening for enabling a user to removably secure the apparatus during use, thereby enabling the user to use the apparatus in a washing process.

7. The apparatus as recited in claim 6, further comprising a closure device for generally maintaining said pocket in a closed position during use.

8. The apparatus as recited in claim 6, further comprising an exfoliating material joined to said covering member for enabling the user to deep clean during the washing process.

9. The apparatus as recited in claim 6, further comprising a loop-like structure for enabling the user to hang the apparatus when not in use.

10. The apparatus as recited in claim 6, further comprising means for joining objects to the apparatus for enabling user entertainment during the washing process.

11. The apparatus as recited in claim 8, wherein said exfoliating material is joined to said second side.

12. The apparatus as recited in claim 6, wherein said pocket is disposed on an upper portion of said first side.

13. The apparatus as recited in claim 6, wherein said pocket further comprises a tight mesh material for generally retaining liquid soap.

14. The apparatus as recited in claim 6, wherein said covering member further comprises a multiple layer material.

15. The apparatus as recited in claim 14, wherein an outside layer of said multiple layer material comprises terrycloth.

16. The apparatus as recited in claim 14, wherein an inside layer of said multiple layer material comprises a sponge like material.

17. The apparatus as recited in claim 6, wherein said covering member has a mitt shape.

18. An apparatus comprising:
a hand-covering mitt comprising a multi-layer material, said hand-covering mitt having a first side, a second side and a lower opening for generally enclosing a hand space;
a pocket disposed on an upper portion of said first side for retaining a soap, said pocket comprising tight mesh material for generally retaining liquid soap, said tight mesh material having a plurality of apertures for enabling water to enter, and lather from the soap to permeate out through said apertures;
a closure device for generally maintaining said pocket in a closed position during use;
an exfoliating material joined to said second side for enabling the user to deep clean during a washing process;
means for joining objects to the apparatus for enabling user entertainment during the washing process;
a loop joined to said hand-covering mitt for enabling the user to hang the apparatus when not in use; and
a securing device disposed proximate said lower opening for enabling a user to removably secure the apparatus during use, thereby enabling the user to use the apparatus in the washing process.

19. The apparatus as recited in claim 18, wherein an outside layer of said multi-layer material comprises terrycloth.

20. The apparatus as recited in claim 18, wherein an inside layer of said multi-layer material comprises a sponge like material.
